(19) United States
(12) Patent Application Publication
(10) Pub. No.: US 2025/0308141 A1
(43) Pub. Date: Oct. 2, 2025

(54) Methods for obtaining a multimedia element and for enriched rendering, corresponding electronic devices, system, computer program products and media

(71) Applicant: ORANGE, Issy-les-Moulineaux (FR)

(72) Inventors: Julien FAURE, Chatillon (FR); Sonia LAURENT, Chatillon (FR); Sébastien GAVIGNET, Chatillon (FR); Selsebil MAJDOUB, Chatillon (FR)

(21) Appl. No.: 19/092,340

(22) Filed: Mar. 27, 2025

(30) Foreign Application Priority Data
Mar. 27, 2024 (FR) 2403113

(51) Int. Cl. G06T 15/20; G06T 7/73; G06T 19/20; G06V 10/74; G06V 20/20

(52) U.S. Cl. CPC G06T 15/20; G06T 7/73; G06T 19/20; G06V 10/761; G06V 20/20; G06T 2200/08; G06T 2200/24; G06T 2207/20101; G06T 2219/2012

(57) ABSTRACT

A method for obtaining a multimedia element includes: obtaining an audiovisual stream representing a physical environment; and creating a multimedia element granting access to a value of a first parameter of a digital twin relating to a first object of interest of the audiovisual stream, the value being extracted from the digital twin when capturing the audiovisual stream. An enriched rendering method for rendering a first object of interest in a physical environment includes: obtaining a multimedia element, the multimedia element granting access to a first value of a first parameter of a digital twin relating to the first object of interest; obtaining a first audiovisual representation of a first portion of the digital twin taking into account the first acquired value; and rendering the first audiovisual representation in the physical environment. Also provided are corresponding electronic devices, computer program products and media.

### 1. CROSS REFERENCE TO RELATED APPLICATIONS

The present application claims priority to French Patent Application No. FR2403113, filed Mar. 27, 2024, the content of which is incorporated herein by reference in its entirety.

### 2. TECHNICAL FIELD

The present application relates to the field of telecommunications and more specifically to the field of sharing information (for example, via communications (such as asynchronous communications)) between users via communication terminals. It notably relates to a method for obtaining a multimedia element and a method for rendering such a multimedia element, respectively implemented by one or more electronic devices, as well as the corresponding electronic devices, computer program products and recording media.

### 3. PRIOR ART

The use of electronic means for sharing information between individuals is increasingly widespread. In particular, a distinction is made between various communications, such as synchronous communications (such as telephone calls or video conferences) and asynchronous communications (such as e-mail, for example).

Asynchronous communications offer numerous advantages. Thus, they allow information to be transmitted to a recipient without having previously arranged a meeting with them or even having to consider their availability. They therefore help to overcome attendance or timetable constraints. They have become particularly useful, for example, in the professional world, with the globalization of exchanges or the rise of remote working.

Whether the digital communications are synchronous or asynchronous, they can result in difficulties in terms of understanding between interlocutors. In practice, it is often simpler to “pass on a message” (for example, to express a sense and/or give explanations) face to face. As a result, users often resort to video conferencing (or video messaging) solutions. However, the use of video techniques does not resolve all the difficulties in terms of communication between interlocutors, notably in the case of asynchronous communications and/or complex situations.

The aim of the present application is to propose improvements to at least some of the disadvantages of the prior art.

### 4. SUMMARY

An exemplary aspect of the present application aims to improve the situation by means of a method for obtaining a multimedia element, said method comprising:
obtaining an audiovisual stream representing at least one portion in a physical environment;
creating a multimedia element granting access to at least one value of at least one first parameter of a digital twin relating to at least one first object of interest of said audiovisual stream, said value being extracted from said digital twin when capturing said audiovisual stream.

Depending on the embodiments, said physical environment is a real environment or a virtual representation of a real environment, for example.

In at least some embodiments, said multimedia element further comprises at least one audiovisual content item obtained from said captured audiovisual stream.

In at least some embodiments, said audiovisual content is obtained by being extracted from said captured audiovisual stream.

In at least some embodiments, said audiovisual content is obtained by transforming at least one portion of said captured audiovisual stream.

In at least some embodiments, said transformation comprises replacing at least one object of interest in a scene of said captured stream with a virtual representation of said object of interest.

In at least some embodiments, said multimedia element comprises at least two values of said first parameter, with said at least two values corresponding to at least one fluctuation of said first parameter during said capturing step.

In at least some embodiments, said first object is selected, from among the objects of interest detected in said audiovisual stream, by taking into account a current position and/or a current orientation of said first object in at least one scene of said audiovisual stream relative to at least one position and/or one orientation of at least one second object of interest of said audiovisual stream.

In at least some embodiments, said second object relates to an individual present in said audiovisual stream. Said second object can correspond, for example, to a representation of the individual themselves (real character) or to a virtual representation of this individual (an avatar, for example).

In at least some embodiments, said at least one position of said second object comprises a plurality of positions, representing a movement of said second object in said audiovisual stream.

In at least some embodiments, said first object, respectively said second object, is selected, from among the objects of interest detected in said audiovisual stream, by taking into account a visual and/or auditory similarity between said first object, respectively said second object, and at least one reference object.

In at least some embodiments, said first object, respectively said second object, is selected, from among the objects of interest detected in said audiovisual stream, by taking into account a visual and/or audio designation of said first object, respectively of said second object, in at least one scene of said audiovisual stream.

In at least some embodiments, said first object, respectively said second object, is selected, from among the objects of interest detected in said audiovisual stream, by taking into account a manual designation of said first object, respectively of said second object, via a user interface.

In at least some embodiments, said manual designation is performed during and/or after said capturing step.

In at least some embodiments, said created multimedia element comprises values relating to at least two parameters of said digital twin and said method comprises, after said creation step, filtering said values of said parameters.

In at least some embodiments, said filtering takes into account said objects of interest relating to said parameters.

For example, by virtue of the filtering, only parameter values relating to certain objects of interest can be retained or only parameter values relating to certain objects of interest can be deleted.

According to another aspect, the present application relates to an enriched rendering method for rendering at least one first object of interest in a physical environment, said method comprising:
obtaining a multimedia element, said multimedia element granting access to at least one first value of at least one first parameter of a digital twin at least relating to said first object of interest;
obtaining at least one first audiovisual representation of at least one first portion of said digital twin taking into account said first obtained value;
   rendering said first audiovisual representation in said physical environment.

In at least some embodiments, said first value is a value, at an instant before said step of obtaining said multimedia element, of said parameter.

In at least some embodiments, said at least one first portion of said digital twin comprises said first object of interest.

In at least some embodiments, said multimedia element grants access to at least one audiovisual content item relating to said first object of interest and the method comprises rendering, together with said rendering of said first audiovisual representation, at least one portion of said audiovisual content.

In at least some embodiments, the enriched rendering method comprises rendering, together with said rendering of said first audiovisual representation, a second audiovisual representation of at least one second portion of said digital twin taking into account at least one current value of said parameter of said digital twin.

In at least some embodiments, said at least one second portion of said digital twin comprises said first object of interest.

In at least some embodiments, said enriched rendering method comprises highlighting said at least one first object of interest in said first, respectively second, audiovisual representation.

In at least some embodiments, said rendering of said first audiovisual representation is conditionally implemented by taking into account a presence of a participant in said physical environment.

In at least some embodiments, said rendering of said first audiovisual representation is conditionally implemented by taking into account a profile of said present participant.

In at least some embodiments, said rendering of said first audiovisual representation is conditionally implemented by taking into account a geographical proximity between said present participant and an equipment in said physical environment.

In at least some embodiments, said equipment belongs to a group comprising:
a rendering device implementing said enriched rendering method;
a device for rendering said first and/or second audiovisual representation;
   said at least one first object of interest.

The features that are presented separately in the present application, with reference to some embodiments of at least one of the obtaining and/or rendering methods of the present application, can be combined together into other embodiments of this method.

According to another aspect, the present application also relates to an electronic device adapted to implement at least one of the obtaining and/or enriched rendering methods of the present application in any one of the embodiments thereof.

For example, the present application thus relates to an electronic device comprising at least one processor configured to obtain a multimedia element, said obtaining comprising:
obtaining an audiovisual stream representing at least one portion in a physical environment;
creating a multimedia element granting access to at least one value of at least one first parameter of a digital twin relating to at least one first object of interest of said audiovisual stream, said value being extracted from said digital twin when capturing said audiovisual stream.

For example, the present application thus relates to an electronic device comprising at least one processor configured for enriched rendering of at least one first object of interest in a physical environment, with an implementation of said enriched rendering comprising:
obtaining a multimedia element, said multimedia element granting access to at least one first value of at least one first parameter of a digital twin at least relating to said first object of interest;
obtaining at least one first audiovisual representation of at least one first portion of said digital twin taking into account said first obtained value;
   rendering said first audiovisual representation in said physical environment.

According to another aspect, the present application also relates to a telecommunications system comprising at least one first electronic device adapted to implement the obtaining method of the present application in any one of the embodiments thereof and at least one second electronic device adapted to implement the rendering method of the present application in any one of the embodiments thereof.

Thus, the present application relates, for example, to a telecommunications system comprising at least one first electronic device comprising at least one processor configured for obtaining a multimedia element, said obtaining comprising:
obtaining an audiovisual stream representing at least one portion in a physical environment;
creating a multimedia element granting access to at least one first value of at least one first parameter of a digital twin relating to at least one first object of interest of said audiovisual stream, said first value being extracted from said digital twin when capturing said audiovisual stream.

The telecommunications system further comprises at least one second electronic device comprising at least one processor configured for enriched rendering of said at least one first object of interest, with an implementation of said enriched rendering comprising:
obtaining said multimedia element;
obtaining at least one first audiovisual representation of at least one first portion of said digital twin taking into account said first value;
rendering said first audiovisual representation in said physical environment.

The present application also relates to a computer program comprising instructions for implementing the various embodiments of at least one of the aforementioned obtaining and/or enriched rendering methods, when the program is executed by a processor and a storage medium that can be read by an electronic device and that stores the computer program, as well as to the corresponding storage medium.

For example, the present application thus relates to a computer program comprising instructions for implementing, when the program is executed by a processor of an electronic device, a method for obtaining a multimedia element, said method comprising:
obtaining an audiovisual stream representing at least one portion in a physical environment;
creating a multimedia element granting access to at least one value of at least one first parameter of a digital twin relating to at least one first object of interest of said audiovisual stream, said value being extracted from said digital twin when capturing said audiovisual stream.

For example, the present application thus relates to a computer program comprising instructions for implementing, when the program is executed by a processor of an electronic device, an enriched rendering method for rendering at least one first object of interest in a physical environment, said method comprising:
obtaining a multimedia element, said multimedia element granting access to at least one first value of at least one first parameter of a digital twin at least relating to said first object of interest;
obtaining at least one first audiovisual representation of at least one first portion of said digital twin taking into account said first obtained value;
   rendering said first audiovisual representation in said physical environment.

For example, the present application also relates to a storage medium that can be read by a processor of an electronic device and that stores a computer program comprising instructions for implementing, when the program is executed by the processor, a method for obtaining a multimedia element, said method comprising:
obtaining an audiovisual stream representing at least one portion of a physical environment;
creating a multimedia element granting access to at least one value of at least one first parameter of a digital twin relating to at least one first object of interest of said audiovisual stream, said value being extracted from said digital twin when capturing said audiovisual stream.

For example, the present application also relates to a recording medium that can be read by a processor of an electronic device and that stores a computer program comprising instructions for implementing, when the program is executed by the processor, an enriched rendering method for rendering at least one first object of interest in a physical environment, said method comprising:
obtaining a multimedia element, said multimedia element granting access to at least one first value of at least one first parameter of a digital twin at least relating to said first object of interest;
obtaining at least one first audiovisual representation of at least one first portion of said digital twin taking into account said first obtained value;
   rendering said first audiovisual representation in said physical environment.

The aforementioned programs can use any programming language, and can be in the form of source code, object code, or of intermediate code between source code and object code, such as in a partially compiled format, or in any other desirable format.

The information (or storage) media mentioned in the present application can be any entity or device capable of storing the program. For example, a medium can include a storage means, such as a ROM, for example, a CD-ROM or a microelectronic circuit ROM, or even a magnetic recording means.

Such a storage means can be, for example, a hard disk, a flash memory, etc.

Moreover, an information medium can be a transmissible medium such as an electrical or optical signal, which can be routed via an electrical or optical cable, by radio or by other means. A program according to an exemplary aspect of the present application particularly can be downloaded from a network such as the Internet.

Alternatively, an information (or storage) medium can be an integrated circuit incorporating a program, with the circuit being able to execute or to be used to execute any one of the embodiments of at least one of the methods that is the subject matter of the present application. In general, in the present application, the obtaining of an element is understood to mean, for example, receiving this element from a communication network, acquiring this element (via, for example, user interface elements or sensors), creating this element by various processing means such as by copying, encoding, decoding, transforming, etc., and/or accessing this element from a local or remote storage medium accessible to at least one device at least partially implementing this obtaining.

### 5. BRIEF DESCRIPTION OF THE DRAWINGS

Further features and advantages of one or more aspects of the present application will become more clearly apparent upon reading the following description of particular embodiments, which are provided by way of mere illustrative and non-limiting examples, and the appended drawings, in which:

FIG. 1 shows a simplified view of a system, cited by way of an example, in which at least some embodiments of the obtaining and enriched rendering methods of the present application can be implemented;

FIG. 2 shows a simplified view of a device able to implement at least some embodiments of the obtaining and/or enriched rendering method of the present application;

FIG. 3 shows an overview of the obtaining method of the present application, in some of the embodiments thereof;

FIGS. 3A and 3B show an overview of the obtaining method of the present application, in some of the embodiments thereof;

FIG. 4 shows an overview of the enriched rendering method of the present application, in some of the embodiments thereof;

FIG. 5 illustrates an example of obtaining a multimedia element and of enriched rendering of an initial object of interest from this multimedia element according to at least some embodiments of the methods of the present application.

### 6. DETAILED DESCRIPTION OF ILLUSTRATIVE EMBODIMENTS

The aim of a non-limiting exemplary aspect of the present application is to provide a new solution, likely to facilitate communications, notably asynchronous communications, between users of a telecommunications system. For example, it can assist a user in describing, optionally in addition to a message comprising audiovisual content, at least one object of interest in a physical, real environment (or, as a variant, a virtual representation of this environment) that can vary according to the embodiments. For example, it can involve a factory, a garden or a public place. This physical environment will also be referred to as the “capturing environment” in the present application.

More specifically, the present application proposes, according to a first aspect, creating, on the initiative of a “producer” user, a multimedia element notably obtained from an audiovisual stream (for example, a video sequence) representing a first portion of the physical environment, with this first portion comprising an object of interest (notably for the “producer” user) or being located in the vicinity of such an object. The multimedia element comprises (or grants access to) information relating to the object of interest, obtained when capturing the audiovisual stream, and originating from a digital twin. This information can relate to, for example, the current state of the representation of the object of interest in the digital twin when capturing the audiovisual stream, and/or to its identification, and/or to its positioning. The information can include at least one audiovisual representation of this object of interest, etc.

Optionally, the multimedia element can include (or grant access to) audiovisual content obtained from at least one portion of the captured audiovisual stream.

The digital twin can be, for example, a digital twin specific to the object of interest or a digital twin at least relating to the first portion of the physical environment (for example, a digital twin of the complete physical environment (i.e., as a whole) optionally including avatars of individuals present in the environment). As a variant, the multimedia element can include, not the information relating to the object of interest in the digital twin, but a link granting access to this information. The multimedia element therefore includes information from a digital twin relating to at least one object of interest in the audiovisual stream and can optionally include audiovisual content at least partially derived from this stream and related to this object of interest.

According to a second aspect, at least some of the data relating to the created multimedia element then can be restored (rendered) at a later instant for a “consumer” user. The rendering can vary according to the embodiments. For example, in some embodiments, it can involve rendering at least some of the information of the digital twin (such as parameter values) included in the multimedia element (or, as a variant, to which the multimedia element grants access) and joint rendering of at least one audiovisual representation (i.e., audio and/or visual) of at least one object of interest relating to at least one information item of the digital twin obtained from the multimedia element. In some embodiments, the rendering can also include rendering (together with the information of the digital twin and the audiovisual representation) audiovisual content included in the multimedia element (or, as a variant, to which it grants access). As explained above, the information included in the multimedia element (or, as a variant, to which it grants access) was obtained when capturing an audiovisual stream comprising an object of interest relating to at least some of this information. The rendered content notably may have been obtained from the captured audiovisual stream.

In some embodiments (for example, when the information from the multimedia element is timestamped), the rendering of this information can be, for example, temporally synchronized with the rendered audiovisual representation and/or with the optionally rendered content. In some embodiments, the rendering of data related to the multimedia element can include joint rendering of information from the digital twin included in the multimedia element and information from the digital twin at the current instant equivalent to the rendered information included in the multimedia element (such as the joint rendering of parameter values of the digital twin included in the multimedia element (and relating to the moment of capture) and the current values of these parameters).

For example, the rendering can include information from the digital twin representing the position of the object of interest in the physical environment when the audiovisual stream was captured. According to another example, the rendering can include rendering of information from the digital twin relating to the state of the object of interest when capturing and equivalent information from the digital twin (same parameter) relating to the current state (when rendering) of the object of interest.

The rendering can also optionally Include other information comprised in the multimedia element (for example, at least one timestamp relating to the capture of the audiovisual stream, or information relating to the status of the digital twin when the audiovisual stream was captured).

The content obtained from the captured stream can represent, for example, a first object of interest and a second object of interest in the physical environment, with the second object of interest being, for example, an individual (real or an avatar), such as the producer user or a third party, present in the physical environment and indicating (via visual or vocal indications, for example) or interacting with the first object of interest.

Thus, by virtue of the method of the present application, an individual can be filmed, for example, (in an audiovisual stream) while they indicate or look at certain elements in the physical environment, which then will be rendered (for example, during subsequent rendering of at least one portion of the film) in their position when the film was captured. The rendering notably also can be carried out in the physical environment, so as to render the indicated elements “in situ” and, optionally, (in the case of mixed reality rendering), by highlighting their current position. Such an embodiment can assist in highlighting a movement of an object of interest between the capturing and the rendering thereof.

Such a method can thus assist a producer user in more easily generating explanations and at the same time make them easier for a consumer user to understand.

According to the embodiments, the multimedia element may be intended to be communicated (i.e., transmitted) to a third party (“recipient”) via a communication (for example, asynchronous), or to be simply made available, for enriched rendering of an object of interest of this multimedia element, to a potential third party “consumer”. For example, the enriched rendering can be implemented at the request of a third party (authenticated, for example) or even without any initiative from the third party (for example, it can be continuous rendering (loop playback) or rendering performed following the detection of a passage in the vicinity of a device for the enriched rendering of the object of interest.

By way of an example, the present application can notably apply when objects are moving when capturing an audiovisual stream (the message of a “producer” user). Indeed, it can be worthwhile saving these movements for proper understanding of the message. The present application proposes a solution that allows, for example, an in situ “message” to be created (for subsequent enriched rendering) that takes into account possible changes, between the moment the stream is captured and the rendering of the “message”, in the physical environment where the stream containing this message was captured.

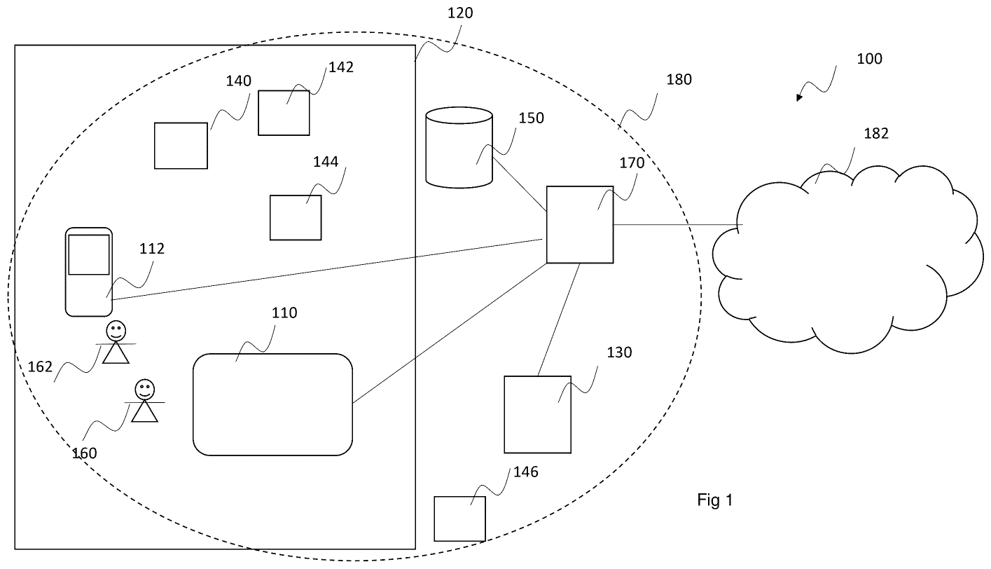

The present application will now be described in more detail with reference to FIG. 1.

FIG. 1 shows a telecommunications system 100 in which some embodiments of the present application can be implemented. The system 100 comprises one or more electronic devices, at least some of which are able to communicate with one another via one or more, optionally interconnected, communication networks 180, 182 (via, for example, an interconnection device 170 (also called gateway), such as a LAN (Local Area Network) and/or a WAN (Wide Area Network). Examples of networks can include a business or domestic LAN and/or an Internet WAN or cellular GSM (Global System for Mobile Communications), UMTS (Universal Mobile Telecommunications System),—Wi-Fi—Wireless network, etc.

As illustrated in FIG. 1, the system 100 can also comprise one or more electronic devices, such as a terminal 110, 112 (such as a laptop computer, a smartphone and/or a tablet), and a mixed or virtual augmented reality headset, a connected object 140, and/or a server 130, for example, an application server, and a storage device 150. The system can also comprise network management and/or interconnection elements (not shown). These electronic devices can be associated with at least one user 160, 162 (for example, by means of a login-accessible user account), with some of the electronic devices 110, 112 being able to be associated with the same user 160 or to be shared by several users 160, 162.

In the present application, a connected object (or “smart object”) refers to an electronic device with components (hardware or software) that enable it to perform a function (action, provision of a service, acquisition of information concerning its physical environment, etc.), means (such as a microcontroller) for controlling these components for completing this function, and means for communicating within a communication network, notably allowing the acquisition and/or provision of information associated with the completion of the function. For example, a connected object can acquire information relating to its current physical environment and transmit it over the network, or receive a command from the communication network to perform an action.

Some of the devices of the system 100 can process (for example, create and/or store and/or modify and/or manipulate and/or delete) information relating to a physical environment 120 where one or more objects 140, 142 are present. Some of these objects 140 can be connected objects belonging to the system 100 (therefore, “devices” of the system 100), while other objects 142 can be “non-connected” objects without communication means. It should be noted that the concept of an object used herein includes not only inert structures but also living structures, such as trees, animals or individuals.

The information relating to the physical environment can represent a current (actual) state of the physical environment and/or a state, an activity or a position (location, orientation, mobility, etc.) of at least some of the objects (connected or otherwise) that it contains or that are located in the vicinity of this physical environment.

For example, some information can relate to objects 146 not present in the physical environment but that affect this physical environment.

In the present application, the term “digital twin” of a real object refers to a model of this real object based on a set of information relating to this real object. This information can particularly represent its current state and/or its links or interactions with other objects. Similarly, the term “digital twin” will be used to refer to a physical environment including at least one real object, a model of this physical environment using a set of information relating to the physical environment as a whole, and/or to at least some of the real objects it contains and/or to their interactions. Thus, a digital twin is a digital representation, at a current instant, of the object or physical environment with which it is associated. In the same way that the physical environment can include or contain one or more objects, the digital twin of the physical environment can include digital twins of objects from the physical environment to which it corresponds, or can have at least partial access to the digital twins of the objects from the physical environment.

The digital twin can therefore evolve with the evolution of the object or physical environment it represents.

It should be noted that the information relating to a real object can be acquired via the real object itself (if it has means for communicating with at least one other device of the system 100) or via another object or device (such as, for example, a camera outside this object but with this object in its field of vision and therefore able to transmit information relating to the state or movement of this object).

According to another example, a digital twin can be periodically or continuously supplied with data collected via sensors placed on and/or in and/or in the vicinity of the real object or the physical environment, or with data derived from an operator inspecting this object at least at a certain instant.

Examples of sensors include microphones, motion sensors, pressure sensors, eye-tracking devices, cameras (such as multi-sensor cameras capable of producing a 3D representation (in wireframe, for example) of a real object in the physical environment and of detecting and locating real objects in the physical environment).

In some embodiments, a digital twin can be obtained and/or enriched by mapping (via spatial recognition, for example).

Thus, unlike conventional digital modelling, a digital twin is configured to provide, at any instant, information concerning the current operating state of the object or the physical environment to which it is connected.

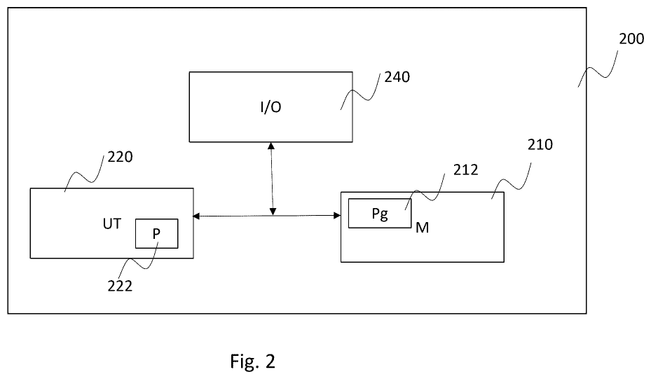

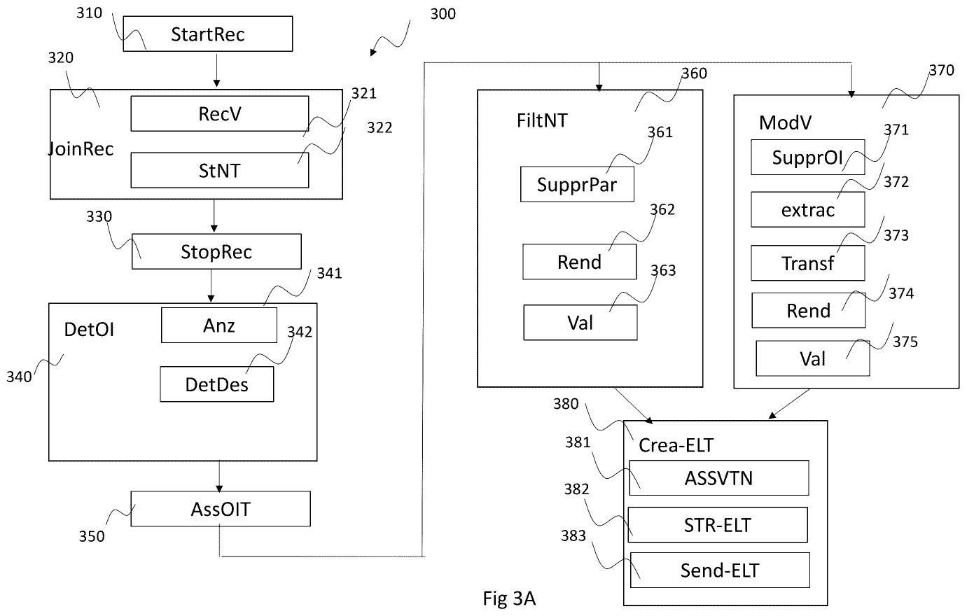

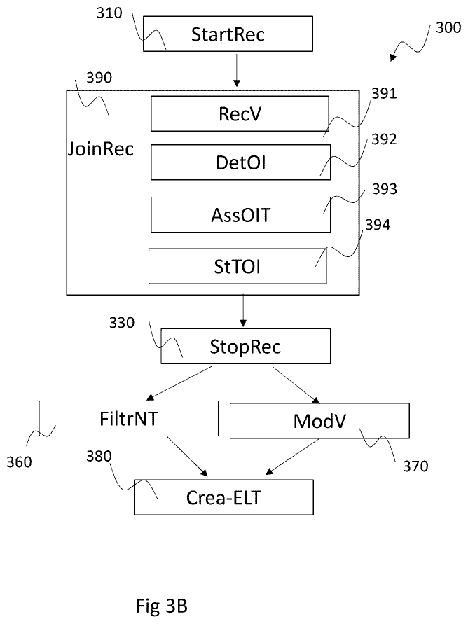

FIG. 2 illustrates a simplified structure of an electronic device 200 of the system 100, for example, the device 110, 112, 130 or 140 of FIG. 1, adapted to implement the principles of the present application. According to the embodiments, this can be a server, and/or a terminal. The device 200 notably comprises at least one memory M 210. The device 200 can notably comprise a buffer memory, a volatile memory, for example, a RAM (Random Access Memory), and/or a non-volatile memory, a ROM (Read-Only Memory), for example. The device 200 can also comprise a processing unit UT 220, equipped, for example, with at least one processor P 222, and controlled by a computer program PG 212 stored in the memory M 210. On initialization, the code instructions of the computer program PG are loaded, for example, into a RAM memory before being executed by the processor P. Said at least one processor P 222 of the processing unit UT 220 can notably implement, individually or collectively, any one of the embodiments of at least one of the obtaining and/or enriched rendering methods of the present application (notably as described with reference to FIGS. 3A, 3B, 4 and 5), according to the instructions of the computer program PG.

The device can also comprise, or be coupled to, at least one I/O (input/output) module 230, such as a communication module allowing, for example, the device 200 to communicate with other devices of the system 100, via wired or wireless communication interfaces, and/or such as a module for interfacing with a user of the device (also more simply referred to as “user interface” in this application).

A user interface of the device is understood to mean, for example, an interface integrated into the device 200, or part of a third-party device coupled to this device by wired or wireless communication means. For example, this can be a secondary screen of the device, a camera (for acquiring gestural commands of an operator, for example) or a set of loudspeakers connected to the device via wireless technology.

A user interface notably can be an “output” user interface, able to render (or to control the rendering of) an output element of a computer application used by the device 200, for example, an application at least partially running on the device 200 or an “online” application running at least partially remotely, for example, on the server 140 of the system 100. Examples of an output user interface of the device include one or more screens, notably at least one graphics screen (a touchscreen, for example), one or more loudspeakers, a connected headset (notably a mixed or virtual augmented reality headset).

Rendering is understood herein to mean rendering (or outputting) over at least one user interface, in any form, for example, comprising textual, audio and/or video components, or a combination of such components.

Moreover, a user interface can be an “input” user interface, suitable for acquiring a command from a user of the device 200. It can notably involve an action to be performed with reference to an item rendered by the device 200, and/or a command to be transmitted to a computer application used by the device 200, for example, an application at least partially running on the device 200 or an “online” application running at least partially remotely, for example, on the server 140 of the system 100. Examples of an input user interface of the device 200 include a sensor, an audio and/or video acquisition means (for example, a microphone, a camera (webcam), an eye-tracking device), a means for acquiring a command (one or more keys, for example, a keyboard, a button, a mouse, a touchscreen actuator), etc.

Said at least one microprocessor of the device 200 notably can be adapted to implement at least one of the methods of the present application.

Thus, said at least one microprocessor of the device 200 notably can be adapted to obtain a multimedia element, said obtaining comprising:
obtaining an audiovisual stream representing at least one portion in a physical environment;
creating a multimedia element granting access to at least one value of at least one first parameter of a digital twin relating to at least one first object of interest of said audiovisual stream, said value being extracted from said digital twin when capturing said audiovisual stream.

Thus, said at least one microprocessor of the device 200 notably can be adapted for enriched rendering of at least one first object of interest in a physical environment, with an implementation of said enriched rendering comprising:
obtaining a multimedia element, said multimedia element granting access to at least one first value of at least one first parameter of a digital twin at least relating to said first object of interest;
obtaining at least one first audiovisual representation of at least one first portion of said digital twin taking into account said first obtained value;
   rendering said first audiovisual representation in said physical environment.

It should be noted that, in some embodiments, the device can be adapted to both implementing the obtaining method and the enriched rendering method of the present application. In other embodiments, by contrast, the obtaining of the multimedia element and the enriched rendering can be implemented by different devices.

Some of the above input-output modules are optional and therefore can be absent from the device 200 in some embodiments. Notably, if the present application is sometimes described with reference to a device communicating with at least one second device of the system 100, at least one of the obtaining and/or rendering methods also can be locally implemented by a device (for example, when the digital twin of the physical environment is local to the device and the device implements both the obtaining method and the enriched rendering method of this application locally (at different instants, for example)).

Otherwise, in some of its embodiments, at least one of the obtaining and/or rendering methods can be implemented in a distributed manner between at least two devices 110, 112, 130, 140, 150, 170 of the system 100.

The term “module” or the term “component” or “element” of the device is understood herein to mean a hardware element, notably a wired hardware element, or a software element, or a combination of at least one hardware element and of at least one software element. The method according to exemplary aspects of the present application therefore can be implemented in various ways, notably in wired form and/or in software form.

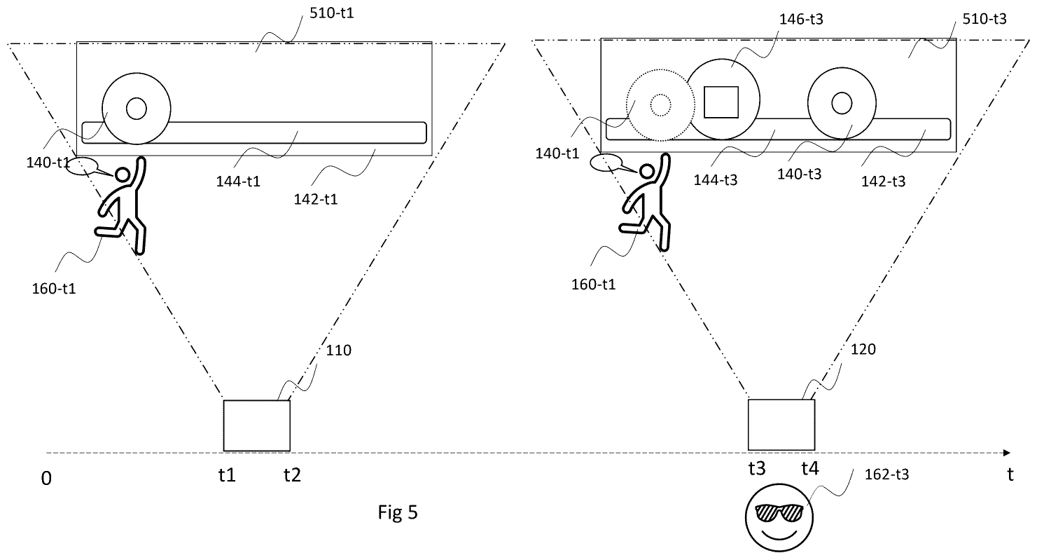

Some embodiments of the obtaining method 300 of the present application will now be described in further detail. Some embodiments are described with reference to FIGS. 3A and 5, other embodiments are described with reference to FIGS. 3B and 5. The same numbering is used in FIGS. 3A and 3B to designate identical or similar elements. The method 300 of FIGS. 3A and/or 3B can be implemented, for example, by the electronic device 200 illustrated in FIG. 2.

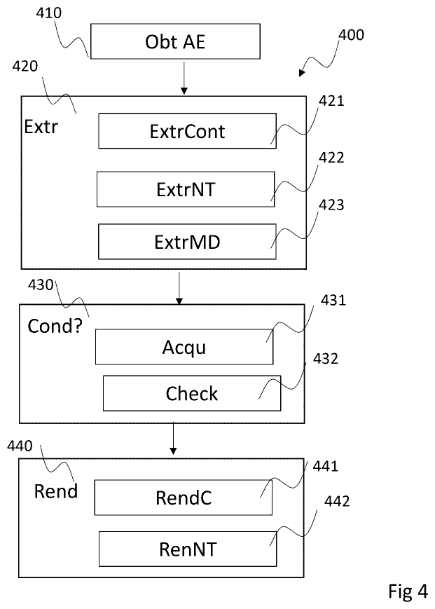

Some embodiments of the rendering method of the present application are then described with reference to FIGS. 4 and 5. The rendering method, in the embodiments described with reference to FIGS. 4 and 5, notably can be used to process elements derived from the obtaining method of FIGS. 3A and 5 or of FIGS. 3B and 5.

FIG. 5 is a simplified illustration of an example of the implementation of the obtaining and rendering methods at different instants.

As shown in FIG. 3A, the method 300 can comprise (step 320) joint time-synchronized recordings 321, 322 of audiovisual content (recording 321) obtained from an audiovisual stream capturing a scene (audio and/or video) from a physical environment, and information from at least one digital twin (recording 322), in its current state (i.e., when the stream was captured). This information notably relates to at least one physical object present in or in the vicinity of the captured scene.

In the example in FIG. 5, a recording 321 notably representing a first interlocutor 160 is triggered at the instant t1. In the illustrated example, this recording 321 corresponds to an acquisition of a video sequence (or, as a variant, of a plurality of images) capturing the scene 510-t1. This scene unfolds in a portion in a physical environment (such as the physical environment 120 in FIG. 1). The portion of the environment includes several objects (140, 142, 144, 160), whose respective positions (140-t1, 142-t1, 144-t1, 160-t1) at the instant t1 are illustrated in FIG. 5. Thus, the interlocutor 160, for their part, is an object of interest in this example.

In the example in FIG. 5, the recording notably representing the interlocutor 160 and the recording of the parameters of the digital twin of the environment both stop at an instant t2.

At least some information relating to capturing the scene (such as a location (position, orientation, field width, etc.) of the captation) can be recorded (saved) in association with the video sequence.

Furthermore, at least some information from the digital twin of the physical environment is recorded (stored) alongside the recording of the video sequence. This information can relate, for example, to objects present in the captured scene (such as the objects 140, 142, 144, 160).

As illustrated in FIG. 3A, in some embodiments, the same command 310 can trigger both the recording 321 of the audiovisual content and the recording 322 of parameters of the digital twin of the environment. Similarly, the same command 330 can trigger both stopping the recording of the audiovisual content and the parameters of the digital twin.

In other embodiments, separate commands can control each of the recordings.

A start or stop recording command can be received, for example, via an input interface of the device 200 (for example, by activating a physical element of the device such as a physical button) or via a communication interface of the device 200 (for example, a command originating from the telephone or headset of the “producer” user and received via a wireless communication interface of the device 200).

For the sake of simplicity, in FIG. 5 it was considered that between the instants t1 and t2 the objects 140, 142, 144 and 160 had not moved. Of course, in some embodiments, at least some of the objects of interest (or other elements of the captured scene) (notably the interlocutor 160 in this example) may be moving during recording. In some embodiments, the origin, the direction and/or the shooting angle can also fluctuate during recording (scanning a scene or zooming in on an interlocutor, for example).

According to the embodiments, the parameters of the digital twin can be recorded 332 at regular intervals when recording the audiovisual content, and/or during particular events (beginning and/or end of recording, change in the state of a parameter (fluctuation in its value), such as a status and/or a position, the occurrence of an unexpected event (intrusion and/or fire alarm, and/or the failure of equipment in the physical environment, etc.). Repeated recording of a parameter of an object of interest can help to highlight a change of state and/or a movement and/or a modification and/or an alteration of an object of interest while it is captured. Recording the value of a parameter of the digital twin only when it fluctuates can help to limit the memory occupied by recording the digital twin, which can prove to be significant in some embodiments, for example, in some embodiments where the digital twin is very complex (therefore, in the updates requiring, for example, significant processing times), and/or where the multimedia element must be generated very quickly (following the occurrence of a critical event, for example), and/or where the obtaining method is executed on a device with very limited memory and/or processing capacities).

In some embodiments where the multimedia element includes one (or more) video components, recording 321 the audiovisual content can limit the recording to a zone of the scene located in the vicinity of a reference point (for example, an object of interest such as an interlocutor present in the scene). For example, the recorded zone can be a circular or rectangular zone centered on the interlocutor, with the radius, respectively the width/height of said zone, being a constant corresponding to a “maximum” distance (used as a threshold) from the interlocutor. Recording audiovisual content can also include recording at least one metadata relating to the captured audiovisual stream (such as a timestamp of the start and/or end of the recording, links to certain elements of the digital twin, the 3D coordinates or the states of elements in space at the time of recording, features of the device that captured the audiovisual content, a type of encoding of the audiovisual content, etc.).

In the example in FIG. 3A, the method can include recording 332 all the parameters of the digital twin and then filtering 360 the recorded parameters of the digital twin in order to retain only some of these parameters, while taking into account the recorded (and optionally also filtered 371) audiovisual content. This filtering of one or more recorded parameters, such as recorded audiovisual content, can be optional in some embodiments. They are described in further detail hereafter.

In some embodiments, the method can include detecting 340 at least one object of interest in the recorded audiovisual content. This detection 340 can implement an analysis 341 of the audiovisual content, using, for example, image processing and/or audio processing techniques. For example, the analysis 341 can include image processing (for example, motion analysis) for detecting 342 a gestural, vocal or visual indication (for example, by a glance) by an interlocutor (present in at least one captured scene) of at least one region of the acquired scene. More sophisticated image processing (for example, shape detection) also can be performed on the designated region for detecting one or more objects therein (potentially forming one or more objects of interest). In a cumulative or alternative manner, the analysis 341 can include an audio analysis for detecting 342 one or more keywords in a dialogue by the interlocutor that semantically correspond to objects detected (by image processing) in the acquired scene. The interlocutor themselves can potentially form an object of interest.

This analysis can result in, for example, the identification (or detection) of at least one object of interest in the recorded audiovisual stream. In some embodiments, it can also involve detecting, in the acquired scene (via pattern recognition, for example), at least one particular object assimilated (for example, by a prior configuration) as being of interest to the interlocutor and/or to a potential consumer of the video sequence. This can be, for example, a critical object (in terms of its operation and/or due to its hazardousness), and/or an object occupying a significant part of the captured scene, a moving or noisy object in the captured scene and/or a dangerous zone that should not be crossed and/or exceeded by individuals without authorization, etc. It can also involve portions of an object of interest that are more specifically likely to designate and/or interact with another object of interest in the scene (as in the case, for example, where one of the objects of interest is an interlocutor present in the scene, their hands, their legs, their eyes, etc.), that therefore needs to be accurately monitored (tracking) (for example, in order to detect other objects of interest, as explained above). For example, these portions of the object of interest that are more likely to designate and/or interact with another object of interest in the scene can be monitored more accurately than other portions of the object of interest.

Once at least one object of interest has been detected, the method can include matching 350 the object of interest detected in the stream with at least one information item (parameter) of the recorded digital twin (recording 322).

The object of interest can be a connected object 140 with its own digital twin, or a connected object 140 relating to at least one parameter of the digital twin of at least one portion of the environment. The parameters corresponding to the object in the digital twin can include its identifier and/or descriptors of this object, such as its position (location and orientation), its dimensions, its shape, its color, its state and its movement (speed, acceleration, direction, rotation, etc.). The object of interest also can be a non-connected object 142, in which case an estimate of certain parameters describing it (for example, its position relative to connected objects of the digital twin) can be extracted from the acquired scene.

The recorded parameters of the digital twin can correspond not only to objects of interest in the captured scene but also to objects (such as objects 146 located in the vicinity of the captured scene) represented in the digital twin and affecting the captured scene, such as objects that are behind the source of light or noise in the captured scene.

As illustrated in FIG. 3A, the method 300 can include filtering 360 of at least one recorded parameter of the digital twin. The filtering 360 can include the deletion 361 of at least one recorded parameter of the digital twin. For example, this can involve deleting at least one recorded parameter that does not correspond to any object of interest in the content, or that corresponds to an object previously declared (by parameterization, for example) as being of no interest (such as a brush or shavings in an industrial environment, for example).

It can also involve selecting the objects of interest to be retained according to their position (or their orientation) relative to a reference position (or a reference orientation). For example, in the case of a video sequence, the method can include filtering the recorded parameters of the digital twin in order to retain only those relating to objects of interest located in the vicinity of a reference object present in the video (the position of which is considered to be a reference position). This reference object can be, for example, an interlocutor delivering an audio and/or gestural message in the audiovisual content. For example, all the parameters of the digital twin relating to objects of interest located at a distance greater than a first distance from this object (for example, a constant distance set by parameterization) can be deleted.

In the case of a video sequence, in embodiments where the position and/or the orientation of an interlocutor is used as a reference, and where the interlocutor moves, all the parameters of the digital twin relating to objects located at a point in the sequence in the vicinity of the interlocutor can be retained, for example.

As illustrated in FIG. 3A, the method can include a modification 370 of the audiovisual content. This modification can be optional in some embodiments. The modification can include, for example, filtering 371 of the content in order to delete some portions (temporal or spatial) and/or at least one component (audio, visual, etc.) of the audiovisual content so as to retain, for example, only portions of the image representing an object of interest, and/or only a portion of an audio sequence of the interlocutor relating to an object of interest, and/or only an audio component and/or only a visual component.

In some embodiments, the modification 370 can also include obtaining modified audiovisual content corresponding to the extraction 372 of a portion (to be retained in this modified content) of the captured content (for example, the extraction of a silhouette by “clipping” the silhouette in the captured scene).

The modification can include (in addition or alternatively) the transformation 373 of a portion of the content. For example, after a silhouette of a character has been clipped in the audiovisual content, it can be replaced by an avatar of this character, or a hologram of this character. The avatar notably can be correlated with the captured character, with their movements and their expressions.

Related data also can be saved in association with the content (possibly modified), for example, in the form of metadata. Examples of such data can include an identifier of an object (or a portion of an object) present in the audiovisual content (possibly modified), information characterizing the capture, positioning information of an object of the modified content, etc. It should be noted that it can involve absolute positioning information (for example, a GPS position) or relative positioning information (for example, a distance and/or an orientation relative to an object of the digital twin). In particular, for a character, the positioning information can include information relating to the position and/or the movement of certain parts of the body of the character (such as at least one of their limbs (hands, arms, legs, feet, etc.), their head, their mouth, their eyes, their facial expression, etc.).

In some embodiments, the captured audiovisual content can be 3D content.

The filtering of the content can be similar to or consistent (correlated) with the filtering of the recorded parameters of the digital twin, and vice versa, the filtering performed in the content can result in filtering to be performed on the corresponding parameters of the digital twin, and vice versa.

In some embodiments, filtering 360 of the digital twin can include rendering 362 at least some elements of the digital twin. Similarly, the modification 370 of the audiovisual content can include rendering 374 of at least one portion and/or one component of the audiovisual content. This rendering 362, 374 of at least some elements of the digital twin and/or of at least one portion and/or one component of the audiovisual content can be performed before and/or after the automatic deletion of elements of the digital twin and/or at least one modification of a portion and/or a component of the audiovisual content (as described above (when it exists)). Such embodiments can allow an operator (for example, the interlocutor present on the recorded content) to obtain a validation 363, 375 of the elements of the digital twin to be retained and/or the portions and/or components of the audiovisual content to be retained. In particular, the method can include receiving (via a user interface or a communication interface) a command to delete some elements of the digital twin and/or to add some deleted elements, and/or a command to delete some portions and/or components of the audiovisual content and/or to add some deleted portions or components.

These two rendering steps can be optional in some embodiments. These two rendering steps can be performed jointly or separately. The deletion, respectively the addition, of an object of interest can particularly cause the deletion, respectively the addition, of the parameters of the digital twin associated with the object of interest.

The method 300 can also include the creation 380 of a multimedia element comprising the recorded elements of the digital twin (optionally filtered). The multimedia element can also include the audiovisual content (optionally modified).

The audiovisual content and the recorded elements of the digital twin particularly can be associated 381 in the multimedia element, taking into account their respective acquisition instants so as to allow them to be temporally synchronized. For example, in embodiments where the elements of the digital twin and the audiovisual content are timestamped, the association can take into account their respective timestamps. More specifically, the association can take into account a proximity (for example, an equality) between their respective timestamps. The association 381 can also take into account the objects of interest to which they relate.

As illustrated in FIG. 3A, the method can also include storing 382 the created multimedia element (for example, for subsequent rendering on the device implementing the obtaining method, or for rendering from a device coupled thereto) and/or transmitting 383 this multimedia element to at least one other device (for example, another device of the system 100 implementing the rendering method described with reference to FIGS. 4 and 5).

It should be noted that, in some embodiments, transmitting 383 the multimedia element can include transmitting at least one designation of at least one user being a recipient of the multimedia element. The multimedia element (or a link to such an element) can be transmitted, for example, in an electronic message (via various electronic messaging tools according to the embodiments) to at least one recipient user.

This transmission of a designation of at least one recipient can be optional in some embodiments.

In some embodiments (not illustrated in FIG. 3A), filtering 360 the recorded elements of the digital twin (respectively modifying the content 370) can occur after the creation of the multimedia element. In this case, deleting a component of the multimedia element can result in the deletion of a component associated therewith in the multimedia element.

Some embodiments have been described above with reference to FIGS. 3A and 5. In the embodiments illustrated in FIG. 3A, the analysis of the content and the detection of objects of interest via this content, and therefore the consequent filtering of the twin, are performed after the recording of the content has ended (i.e., after the instant t2 according to FIG. 5). Such embodiments can allow any processing to be limited during the content recording phase and therefore allow any processor load peaks in the device 200 to be limited.

Other embodiments will now be described with reference to FIGS. 3B and 5.

FIG. 3B thus illustrates a variant of the embodiments illustrated in FIG. 3A. In this variant, notably, joint recording 390 differs from the joint recording 320 in FIG. 3A. Thus, the audiovisual content is analyzed over time, when it is recorded 391 (i.e., between the instants t1 and t2 according to FIG. 5), in order to detect 392 objects of interest, to match 393 information from the digital twin relating to these objects of interest and to record 394 this information over time. The detection 392 and matching 393 can be similar to the detection 341 and matching 350 described with reference to FIG. 3A.

Embodiments as illustrated in FIG. 3B can help to limit the amount of information originating from the recorded digital twin and therefore allow the memory size to be limited that is required to implement the obtaining method.

As described with reference to FIG. 3A, the parameters of the digital twin can be recorded 394 at regular intervals when recording the audiovisual content, and/or during particular events (beginning and/or end of recording, and/or the fluctuation of a parameter, and/or the occurrence of an unexpected event, for example). Such modes can help to limit the size of the created multimedia element.

The start and end of recording commands 310, 330 can be similar to those described in FIG. 3A.

In the embodiment illustrated in FIG. 3B, the modification 370 of the acquired video content and/or the filtering 360 of the information derived from the digital twin also can be performed once the recording is complete. According to the embodiments, this filtering can be the same as or different from the filtering of the embodiments of FIG. 3A. In particular, as the information representing the recorded digital twin only relates to the objects of interest in the recorded video content, further filtering of the recorded digital twin information may be optional. Optionally, rendering and validation by an operator can be implemented in a manner similar to that described with reference to FIG. 3A.

The creation of the multimedia element 380 also can be similar to that described with reference to FIG. 3A.

The recording of audiovisual content captured in the real world has been described above. As a variant, it can involve capturing a scene from a virtual environment, in which case the interlocutor is not a human interlocutor but an avatar present in the virtual environment the scene originates from.

FIG. 4 illustrates some embodiments of the rendering method 400 of the present application. The method 400 can be implemented, for example, by an electronic device such as the device 200 illustrated in FIG. 2. Throughout the remainder of the description, for the sake of simplicity, a “rendering device” will be referred to with regard to the device implementing the rendering method 400, even though the device implementing (at least partially) the rendering method 400 (and controlling the rendering) and the device performing the actual rendering may be different. Indeed, as previously described with reference to FIG. 2, the device implementing the rendering method can be coupled to another device performing the rendering (such as a secondary screen). Throughout the remainder of the application, the term “rendering environment” will be used to refer to the physical environment of the rendering device (and also, for the sake of simplicity, as explained above, to refer to the physical environment of the device in which the rendering method is implemented).

As illustrated in FIG. 4, the method 400 can include obtaining 410 at least one multimedia element. For example, it can involve receiving this multimedia element via a communication interface of the rendering device or read access to a local or remote storage zone for this multimedia element, such as a database (for example, the element 150 in FIG. 1), such as a database common to several devices in the system 100). The multimedia element (or a link to such an element) can be included, for example, in an electronic message received by a user of the rendering device.

As illustrated, the method can include extracting 420 data from (and/or based on) the obtained multimedia element.

For example, the extraction 420 can include extracting 422 (from and/or based on the multimedia element) information from a digital twin, with at least some of this information relating to at least one object of interest in a physical environment. The information relating to an object of interest notably can include an identifier of the object of interest. According to the embodiments, the physical environment the multimedia element refers to can be the rendering environment or another environment.

For example, in some embodiments, the rendering method is implemented to render a multimedia element representing and/or granting access to information (at an instant preceding the current instant) concerning a digital twin of at least one object of interest located in the rendering environment, and optionally granting access to audiovisual content acquired (at this previous instant) in the same place.

In some embodiments, the rendering method is implemented to render a multimedia element received from a third party and representing information (at an instant preceding the current instant) concerning a digital twin of at least one object of interest located in a physical environment remote from the rendering environment. Such embodiments can be applied, for example, for transmitting a report (including this multimedia element) from an operator to a remote monitor, or even for transmitting instructions (including this multimedia element) from a trainer to an operator (who must apply these instructions in a rendering environment close to the physical environment in which the instructions were captured (in the case of twin factories, for example).

Optionally, the extraction 420 can include extracting 421 audiovisual content from (and/or based on) the multimedia element and/or extracting 423 other additional information, for example, related to the content, such as metadata associated with the content and describing, for example, the shooting context of the content, and/or at least one identifier and/or positioning information, in the content, of the object of interest in the physical environment.

Some of this data (notably the audiovisual content itself and at least some of its metadata) can be optional in some embodiments. Embodiments where the multimedia element does not contain any audiovisual content can allow the size of the multimedia element to be limited and consequently can allow the associated processing time to be limited, which can help more fluid rendering of digital twin information to be obtained than when, in conjunction with their rendering, audiovisual content (for example, video) is rendered.

The additional information can allow, for example, information from the digital twin extracted from the multimedia element to be associated with an object of interest present in the content. It can also allow, according to another example where the rendering environment corresponds to the physical environment relating to the multimedia element, a point of view (positioning, and/or orientation, and/or field width, etc.) to be determined that is identical (or almost identical) to the point of view for capturing a scene of this content (and/or from which it originates). The at least one positioning information item can include, for example, in the case where the audiovisual content has a visual component (such as a video sequence), a designation of at least one image of the content, as well as the coordinates of at least one pixel representing the object of interest in this image (for example, an offset relative to a reference pixel (for example, the top left corner) of this image).

In some embodiments, the rendering associated with the multimedia element (and which will be described hereafter) can be performed on the command of a user (for example, a recipient of a message including the multimedia element (or a link to such an element)).

In other embodiments, as illustrated in FIG. 4, the rendering can be performed automatically.

In such embodiments, it can be performed systematically upon obtaining the multimedia element, or conditionally, when certain criteria are met. Some criteria can relate to possible prior validation by an operator. In addition, some criteria can relate to the current context of the rendering device. Thus, as illustrated in FIG. 4, in some embodiments, the method can include a verification 430 of the suitability of the current context of the rendering device for rendering the multimedia element. More specifically, the verification can include the acquisition 431 of contextual data from the rendering device. This can involve, for example, acquiring data relating to the positioning of the rendering device (or of a device coupled thereto and implementing the actual rendering), and/or detecting a possible presence in the vicinity of the rendering device (or of a device coupled thereto and implementing the actual rendering), and/or physically identifying and/or recognizing this individual, and/or acquiring a current timestamp. The method can also include a verification 432 of rendering criteria as a function of at least some of the acquired contextual data. For example, the rendering can only be performed when at least one of the verified criteria (or all of them, according to the embodiments) is met.

According to a first example, which is notably applicable when the rendering environment corresponds to the capturing environment, one of the criteria to be verified can be a point of view of the rendering device that is identical to the point of view of a capturing device being the source of at least part of the multimedia element.

According to a second example, the rendering only can be performed when a presence is detected in the vicinity of the rendering device (or of a device coupled thereto and implementing the actual rendering). According to a third example, which is notably applicable when the rendering environment corresponds to the capturing environment, the rendering only can be performed when a presence is detected in the vicinity of the current position of at least one object of interest relating to at least some of the data extracted from the multimedia element and/or in the vicinity of a position of such an object, as extracted from the multimedia element (i.e., simply the current position of the object of interest when the audiovisual stream through which it was detected was captured). A criterion can be, for example, a presence of the recipient of the message granting access to the multimedia element, or any individual, at a distance shorter than a first distance (such as a constant value set beforehand and used as a threshold value) from the rendering device, and/or of at least one object of interest relating to data extracted from the multimedia element, and/or even of a reference point in the physical (or virtual) environment, such as a portion of the physical environment corresponding to the shooting of the content.

Thus, in embodiments where the rendering environment corresponds to the capturing environment, the rendering can be proposed, via a visual or voice message, to an individual approaching a location corresponding to a current position of at least one of the objects of interest in the content, and/or a position of at least one of the objects of interest in the content when the content was captured, and/or a location corresponding to the shooting position when the content was initially recorded (or can be performed automatically when the individual approaches).

According to another example, which is notably applicable when the rendering environment corresponds to the capturing environment, a rendering criterion can be the presence, in the current physical environment, of at least one object of interest in the multimedia element. Such an embodiment can help to limit the rendering of “obsolete” messages, thus causing unnecessary consumption of CPU resources, on the one hand, and unnecessary disruption for a consumer user, on the other hand. In other embodiments, by contrast, such a criterion may not apply, for example, for helping a consumer user to perceive the disappearance of an object from the physical environment.

In some embodiments, where at least one criterion relates to an authenticated individual, the verification 432 of rendering criteria can include authenticating the individual whose presence has been detected or who is requiring rendering of the multimedia element.

It should be noted that, in some embodiments the rendering criteria applicable to rendering digital twin information and to rendering audiovisual content can differ from each other.

As emphasized above, verifying 430 the suitability of the current context of the rendering device for rendering the multimedia element can be optional, at least in some embodiments.

As illustrated in FIGS. 4 and 5, the method 400 can include rendering 440 at least some of the data from the multimedia element (for example, after verifying rendering criteria as described above).

The rendering can notably include joint rendering of at least one portion of the audiovisual content extracted from the multimedia element (rendering 441) and of at least one of the digital twin information items extracted from the multimedia element (rendering 442).

For example, one of the rendered objects of interest can be an interlocutor (such as the user producing the audiovisual content).

The rendering of at least one object of interest in the content also can be conditional. For example, it can take into account rendering criteria similar to certain criteria to be verified cited by way of an example above (see the verification 432 of rendering criteria). For example, only objects of interest whose positioning information in the multimedia element corresponds to a position in the vicinity of the current position of a “consumer” user of the multimedia element can be rendered.

In the example in FIG. 5, the multimedia element is rendered 440 between instants t3 and t4 in the presence of the “consumer” user 162-t3. The rendering 440 of the multimedia element includes rendering 441 of audiovisual content (a video sequence) 160-t1 extracted from the multimedia element and representing the first interlocutor 160 between the instants t1 and t2. For example, it can be a clip of the interlocutor in the captured video sequence, or an avatar representing the interlocutor and animated in order to take into account the movements made by the interlocutor when capturing the video sequence. According to FIGS. 4 and 5, at least some information of the digital twin is rendered 442 jointly (for example, synchronized) with the rendering of the interlocutor 160. The rendering 442 can include, for example, an audiovisual representation (virtual or real) of at least one object of interest 140, 160 (elements 140-t1 and 160-t1, respectively). According to the embodiments, this visual representation can correspond to the extraction of a portion of the captured audiovisual content or even to a virtual representation generated from the digital twin information when capturing. For the sake of simplicity, both cases will be referred to hereafter as a “captured” visual representation (or rendering of an object “as captured”). In the case where the rendering device is adapted to “augmented reality” or “virtual reality” rendering, the rendering of the one or more objects of interest as captured (140-t1, 160-t1) can be performed, for example, by “superimposing” their current rendering/appearance 140-t3, 160-t3. Thus, the user consumer 162 can consume, for example, a scene in which the interlocutor 160-t1 appears, indicating the object of interest 140-t1, with the same scene also including the element of interest 140-t3 in its current position. The rendering of an object of interest (and/or its representation (graphic or audible)) can grant access, for example, to the parameter of the digital twin extracted from the multimedia element and relating to this object of interest.

In embodiments where the rendering includes the rendering of at least a partial visual representation of the digital twin (in its previous and/or current state), the consumer user can thus see, for example, in situ the recommendations of an interlocutor present in the rendered audiovisual content (for example, 3D) (avatar or a more realistic reconstruction of their face and/or body). The consumer user can optionally move around the physical environment (either in reality or virtually in the case of a virtual representation of this physical environment) in the vicinity of one of the objects of interest (rendered, for example) in order to fully understand and see the important elements mentioned by the interlocutor. Thus, the present application offers new possibilities to a “consumer” user compared to prior art solutions, such as video recordings, where the position, the orientation and the shooting angle of the video recording are, when they are rendered, only those involved in capturing.

According to one example, the moving objects of interest related to the content can appear in 3D as the content is being consumed. In some embodiments, the rendering of an object of interest can include highlighting (via an audible and/or visual indicator, such as a highlight, a particular color, a text, etc.) a fluctuation of at least some information (position, status, etc.) relating to the object of interest. For example, the method can include a comparison between the current state of these objects in the real environment and their state when capturing and, in the event of a fluctuation, the relevant objects can be rendered with this fluctuation highlighted, so as to notify a “consumer” user of this fluctuation.

The indication can be rendered on the object of interest as captured and/or (in embodiments where the current scene is rendered in mixed reality) on the object of interest in its current “state”.

Such embodiments, which allow objects of interest present in the initial scene that have been deleted to be highlighted, or, by contrast, that are still present when rendering in the current scene, can help a consumer user to judge whether or not the rendered multimedia element is of interest in the rendering environment.

Furthermore, such embodiments can help a user to find an object that has been moved since it was captured and that is possibly outside the portion of the environment currently viewed by the consumer user.

In the case of periodically recording information from the digital twin in the multimedia element, the method can include interpolation of the values of the digital twin parameters when rendering (for example, interpolation of the positions of objects of interest (and their orientation) between two recordings).

It should be noted that while FIG. 5 illustrates identical time intervals [t1; t2] and [t3; t4], for the sake of simplicity, in some embodiments these intervals can be different. In this case, the method can include the acceleration or, by contrast, the slowing down of the rendering of the multimedia element (rendering of the digital twin information and optionally of the content) in order to match a desired rendering time. In addition, the consumer user of the content may be able to act on the rendering of the multimedia element (paused, and/or rewound, and/or slowing down the rendering speed (for notably rendering with a speed lower than a “nominal” speed corresponding to the speed for capturing the content) and/or, by contrast, accelerating the rendering speed (notably for rendering with a speed higher than the nominal speed). In such embodiments, rendering the digital twin information can be adapted accordingly, so that the digital twin information remains temporally synchronized with the rendered content.

The obtaining and enriched rendering methods can be applied in many professional or personal fields in order to deal with, for example, situations where a “producer” user has to explain a situation to a “consumer” user in relation to the physical environment around them. Fields such as industry, maintenance, digital business, archiving and information sharing, and/or geolocation thus can be cited.

According to a first example, the methods of the present application can offer an alternative to sending an audio message between operators on a production line (“When you arrive tomorrow and you are in front of the cutter, the one at the back of the factory, on the right, be careful: the activation lever of the cutter on the left is very hard to lower. It is dangerous. Instead, use the button located below the emergency zone. Not the push button, but the small one right next to it”). Thus, by virtue of an exemplary aspect of the present application, rendering a multimedia message can be proposed that more easily highlights an object of interest (in this case the “small push button”) and thus avoids errors of judgement that could have serious consequences for a “consumer” operator.

According to a second example, the methods of the present application can help to describe an object of interest in a museum or a historical building.

According to a third example, the methods of the present application can help with the conditional rendering (after the success of a “consumer” user in solving a puzzle, for example) of a progress message during a geolocation game.

In a variant (not illustrated), the multimedia element can be enriched during/after implementing the rendering method by applying (again) the method for obtaining a multimedia element. For example, other information from a second digital twin and optionally from second audiovisual content representing at least one second object of interest during a second capturing period according to the previously described obtaining method can be added to the information from a first digital twin and to the optional audiovisual content already contained in the multimedia element and representing at least one first object of interest during a first capturing period. Such a variant can allow, for example, a consumer of a multimedia element to respond to a user producing this multimedia element by sending them an enriched version of this multimedia element.

What is claimed is:

1. A method implemented by an electronic device and comprising:
creating a multimedia element granting access to at least one first value of at least one first parameter of a digital twin, said first value being obtained when capturing said audiovisual stream, and said digital twin being related to at least one first physical object of interest captured by said audiovisual stream.

2. The method according to claim 1, wherein said multimedia element further comprises at least one audiovisual content item obtained from said captured audiovisual stream.

3. The method according to claim 1, comprising obtaining said audiovisual content by extracting the audiovisual content from said captured audiovisual stream.

4. The method according to claim 1, wherein said audiovisual content is obtained by transforming at least one portion of said captured audiovisual stream.

5. The method according to claim 1, comprising selecting said first object, from among objects of interest detected in said audiovisual stream, by taking into account a current position and/or a current orientation of said first object in at least one scene of said audiovisual stream relative to at least one position and/or one orientation of at least one second object of interest of said audiovisual stream.

6. The method according to claim 1, comprising selecting said first object from among objects of interest detected in said audiovisual stream, by taking into account a visual and/or auditory similarity between said first object and at least one reference object.

7. The method according to claim 1, comprising selecting said first object from among objects of interest detected in said audiovisual stream, by taking into account a visual and/or audio designation of said first object in at least one scene of said audiovisual stream.

8. The method according to claim 1, comprising selecting said first object from among objects of interest detected in said audiovisual stream, by taking into account a manual designation of said first object via a user interface.

9. The method according to claim 1, wherein said created multimedia element comprises values relating to at least two parameters of said digital twin and wherein said method comprises, after said creating, filtering said values of said parameters.

10. The method according to claim 1, comprising selecting a second object from among objects of interest detected in said audiovisual stream, by taking into account a visual and/or auditory similarity between said second object and at least one reference object.

11. An enriched rendering method for rendering at least one first physical object of interest in a physical environment, said method being implemented by an electronic device and comprising:
obtaining a multimedia element granting access to at least one audiovisual content relating at least to said first physical object of interest and to at least one first value of at least one first parameter of a digital twin, said first value being obtained during capture of an audiovisual stream, said audiovisual content being obtained from said audiovisual stream, and said digital twin being related at least to said first physical object of interest;
obtaining at least one first audiovisual representation of at least one first portion of said first physical object of interest taking into account said first obtained value of said at least one first parameter of said digital twin; and
joint rendering of said first audiovisual representation and of said at least one portion of said audiovisual content.

12. The enriched rendering method according to claim 11, wherein the method comprises rendering, jointly with said rendering of said first audiovisual representation, a second audiovisual representation of at least one second portion of said digital twin taking into account at least one current value of said parameter of said digital twin.

13. The enriched rendering method according to claim 11, wherein said method comprises highlighting said at least one first object of interest in said first audiovisual representation.

14. The enriched rendering method according to claim 11, wherein said joint rendering is conditionally performed by the electronic device implementing said enriched rendering method by taking into account a presence of a participant in a physical environment of said electronic device.

15. The enriched rendering method according to claim 14, comprising conditionally performing said rendering of said first audiovisual representation by taking into account a profile of said present participant.

16. The enriched rendering method according to claim 14, comprising conditionally performing said rendering of said first audiovisual representation by taking into account a geographical proximity between said present participant and an equipment in said physical environment.

17. The enriched rendering method according to claim 16, wherein said equipment belongs to a group consisting of:
the electronic device implementing said rendering method;
a device for rendering said first audiovisual representation;
said at least one first object of interest.

18. A system comprising at least:
a first electronic device comprising at least one processor configured to obtain a multimedia element by:
creating a multimedia element granting access to at least one first value of at least one first parameter of a digital twin, said first value being obtained when capturing said audiovisual stream, and said digital twin being related to at least one first physical object of interest captured by said audiovisual stream; and
a second electronic device comprising at least one processor configured to perform an enriched rendering of said at least one first physical object of interest by:
obtaining said multimedia element granting access to said at least one first value of said at least one first parameter of said digital twin;
obtaining at least one first audiovisual representation of at least one first portion of said first physical object of interest taking into account said first obtained value of said at least one first parameter of said digital twin; and
rendering said first audiovisual representation.

19. A first electronic device comprising at least one processor configured to implement the method according to claim 1.

20. An electronic device comprising at least one processor configured to implement the enriched rendering method according to claim 11.
